(19) United States
(12) Patent Application Publication
(10) Pub. No.: US 2007/0122204 A1
(43) Pub. Date: May 31, 2007

(54) POWDER CONTAINER AND TONER REPLENISHING DEVICE AND IMAGE FORMING APPARATUS INCLUDING THE SAME

(76) Inventor: Emi Kita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/563,844

(22) Filed: Nov. 28, 2006

(30) Foreign Application Priority Data
Nov. 30, 2005 (JP) 2005-347160

(51) Int. Cl. G03G 15/08

(52) U.S. Cl. 399/258

(57) ABSTRACT

In a toner container of the present invention made up of a toner storing body storing toner thereinside and a toner outlet for discharging the toner from the toner storing body, the toner storing body is caused to discharge the toner by vacuum acting thereon from the outside while decreasing its volume, the toner has a tight bulk density D, which refers to the density of the toner measured in a condition wherein air between toner particles is discharged as far as possible by, e.g., tapping, lying in a range of:
0.5<(T/D)/V<0.9 where V denotes the volume of the toner storing body before the start of toner discharge and T denotes the mass of the toner in the toner storing body.

### BACKGROUND OF THE INVENTION

1. Field of the Invention

The present invention relates to a powder container, a toner replenishing device and an image forming apparatus. More particularly, the present invention relates to a powder container of the type including a powder storing body whose volume is reducible and a powder outlet and configured to discharge powder to the outside when vacuum acts thereon and a toner replenishing device and an image forming apparatus including the same.

2. Description of the Background Art

A powder container of the type described is used in various fields. In the field of image forming apparatuses, for example, a powder container for storing toner to be replenished to a developing unit as powder is disclosed in Japanese Patent Laid-Open Publication No. 2004-323062. A toner storing portion included in the above toner container as a powder storing body is implemented by a soft, deformable bag-like material and can shrink or have its volume reduced when vacuum generated by the suction of a screw pump acts thereon.

By contrast, a toner storing portion included in a toner container in the form or a cartridge, bottle or similar hard bottle does not change in shape and remains in the same size as before use even when it is to be discarded after use. In this respect, the toner container taught in the above document is not only easier for the user to handle but also reduces cost necessary for a toner container to be collected from the user's station after replacement and conveyed to the manufacturer.

A toner container, whether it be deformable or not, should preferably be configured to allow as many images as possible to be formed alone and must therefore contain as much toner as possible in its toner storing portion. However, if a deformable toner container is packed with toner to the full capacity of the toner storing portion, it is likely that when a screw pump or similar suction pump is used to suck the toner, the amount of suction becomes unstable or the amount of toner to be left in the toner storing portion increases for the following reason.

A suction pump is adapted for sucking toner together with air around it. Therefore, if the toner storing body is packed with toner to its capacity for replenishing it, the suction pump sucks air together with the toner with the result that substantially entire air between toner particles is discharged. Consequently, the contact area between the toner particles and therefore friction acting between them increases.

A suction pump is configured to suck toner together with air around it. In this configuration, if the toner storing body is packed with toner to its capacity and then the toner is sucked out together with air for replenishment, substantially entire air between toner particles is discharged with the result that the contact area and therefore frictional force acting between the individual toner particles increases. The increase in frictional force results in an increase in a force necessary for moving the individual toner particles, obstructing the movement of the toner particles against the suction force. Should the suction pump be continuously operated in such a condition, air in the toner storing portion would be exhausted before the toner particles, and consequently only toner would be left in the toner storing portion as if vacuum-packed even though the volume of the toner storing portion decreases. The toner so left in the toner storing portion cannot be discharged, so that the entire toner container must be replaced, wasting the residual toner.

The problem stated above occurs with a powder container of the type storing any kind of powder to be consumed and discharging the powder to the outside while reducing its volume when vacuum acts thereon.

### SUMMARY OF THE INVENTION

It is an object of the present invention to provide a powder container of the type including a powder storing body whose volume is reducible and a powder outlet and configured to discharge powder to the outside when vacuum acts thereon, and allowing a minimum of powder to be left therein at the end of discharge to thereby obviate waste;

It is another object of the present invention to provide a toner replenishing device and an image forming apparatus including the above powder container.

In accordance with the present invention, in a toner container made up of a toner storing body storing toner thereinside and a toner outlet for discharging the toner from the toner storing body, the toner storing body is caused to discharge the toner by vacuum acting thereon from the outside while decreasing its volume. The toner has a tight bulk density D, which refers to the density of the toner measured in a condition wherein air between toner particles is discharged as far as possible by, e.g., tapping, lying in a range of:
0.5<(T/D)/V<0.9
where V denotes the volume of the toner storing body before the start of toner discharge and T denotes the mass of the toner in the toner storing body.

### BRIEF DESCRIPTION OF THE DRAWINGS

The above and other objects, features and advantages of the present invention will become more apparent from the following detailed description taken with the accompanying drawings in which:

FIG. 1 is a view showing the general construction of a printer to which a toner container embodying the present invention is applied;

FIG. 2 is an external perspective view showing a toner replenishing device included in the printer of FIG. 1;

FIG. 3 is a section showing the toner replenishing device;

FIG. 4 is an external perspective view showing a toner bottle;

FIG. 5 is an external perspective view showing a toner bottle provided with a reinforcing plate;

FIG. 6 is a section showing a mouth member included in the toner bottle, which is shown in a position mounted to the toner replenishing device;

FIG. 7 is an external perspective view showing the entire printer;

FIG. 8A shows a toner consumption condition to occur when a toner and air ratio is adequate;

FIG. 8B shows a toner consumption condition to occur when the amount of air is excessive;

FIG. 8C shows a toner consumption condition to occur when the amount of air is short;

FIG. 9 is a graph showing irregularity in the amount of toner replenishment occurred when a ratio T/V was varied;

FIG. 10 is a graph showing irregularity in the amount of residual toner occurred when a ratio T/V was varied;

FIG. 11 is a graph showing irregularity in the amount of toner replenishment occurred when a ratio (T/D)/V was varied; and

FIG. 12 is a graph showing irregularity in the amount of residual toner occurred when a ratio (T/D)/V was varied.

### DESCRIPTION OF THE PREFERRED EMBODIMENT

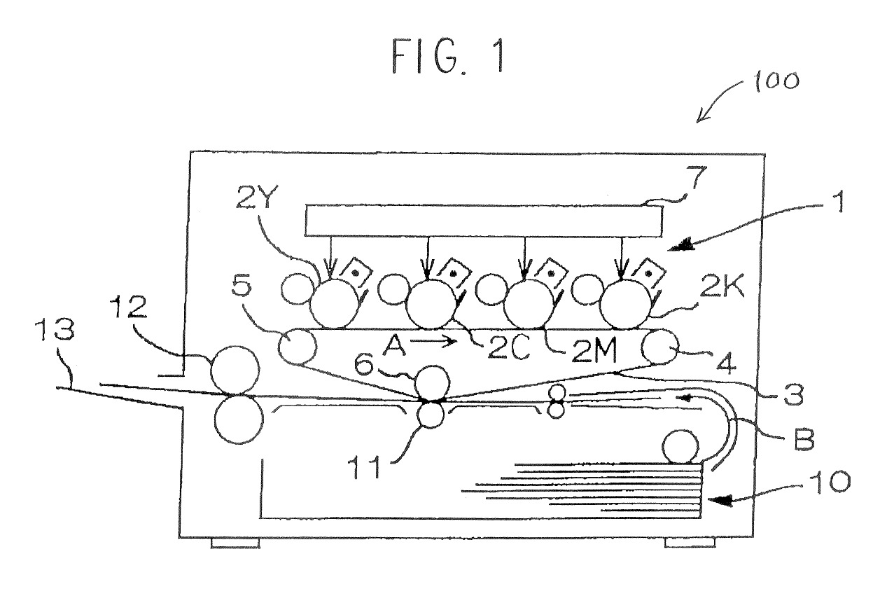

Referring to FIG. 1 of the drawings, an image forming apparatus to which a preferred embodiment of the present invention is applied is shown and implemented as a tandem, color copier by way of example. As shown, the color copier (tandem printer hereinafter), generally 100, includes image forming means 1 for forming a toner image on a recording medium.

As shown in FIG. 1, the tandem printer 1 includes four photoconductive drums 2Y (yellow), 2C (cyan), 2M (magenta) and 2K (black) on which a yellow, a cyan, a magenta and a black toner image, respectively, are to be formed. It is to be noted that the photoconductive drums (simply drums hereinafter) 2Y through 2K are a specific form of image carriers. An intermediate image transfer belt 3 is passed over rollers 5 and 6 while facing the drums 2Y through 2K arranged side by side. One of the rollers 5 and 6 is driven by drive means, not shown, in such a manner as to cause the intermediate image transfer belt 3 to turn in a direction indicated by an arrow A in FIG. 1.

Because configurations for forming toner images on the drums 2Y through 2K and operations thereof all are identical with each other, the following description will concentrate on the configuration for forming a yellow toner image on the image carrier 2Y by way of example. While the drum 2Y is rotated counter clock wise, as viewed in FIG. 1, a charge roller uniformly charges the surface of the drum 2Y to preselected polarity. Subsequently, a laser beam, modulated in accordance with image data and emitted from a laser writing unit 7, scans the charged surface of the drum 2Y to thereby form a latent image on the drum 2Y. A developing unit develops the latent image by depositing yellow toner thereon for thereby producing a yellow toner image.

An image transfer roller, not shown, is positioned to substantially face the drum 2Y with the intermediary of the intermediate image transfer belt 3. A voltage opposite in polarity to the toner deposited on the drum 2Y is applied to the image transfer roller with the result that the yellow toner image is transferred from the drum 2Y to the intermediate image transfer belt 3. A drum cleaner or cleaning unit removes the toner left on the drum 2Y without being transferred to the intermediate image transfer belt 3.

A cyan, a magenta and a black toner image are formed on the other drums 2C, 2M and 2K, respectively, in exactly the same manner as the yellow toner image. Such toner images are sequentially transferred from the drums 2C, 2M and 2K to the intermediate image transfer belt 3 above the yellow toner image, completing a full-color toner image.

On the other hand, a paper sheet, resin sheet, resin film a or similar recording medium (sheet hereinafter) P is fed from a sheet feeding section 10, which is arranged below the image forming means 1, toward the roller 6 associated with the intermediate image transfer belt 3 in a direction indicated by an arrow B in FIG. 1. A secondary image transfer roller 11 is located to substantially face the roller 6 with the intermediary of the intermediate image transfer belt 3. When the sheet P is conveyed to the nip between the intermediate image transfer belt 3 and the secondary image transfer roller 11, a voltage opposite in polarity to the toner is applied to the roller 11 in order to transfer the full-color toner image from the belt 3 to the sheet P. After the full-color toner image has been fixed on the sheet P by a fixing unit 12, the sheet or print is driven out to a print tray 13.

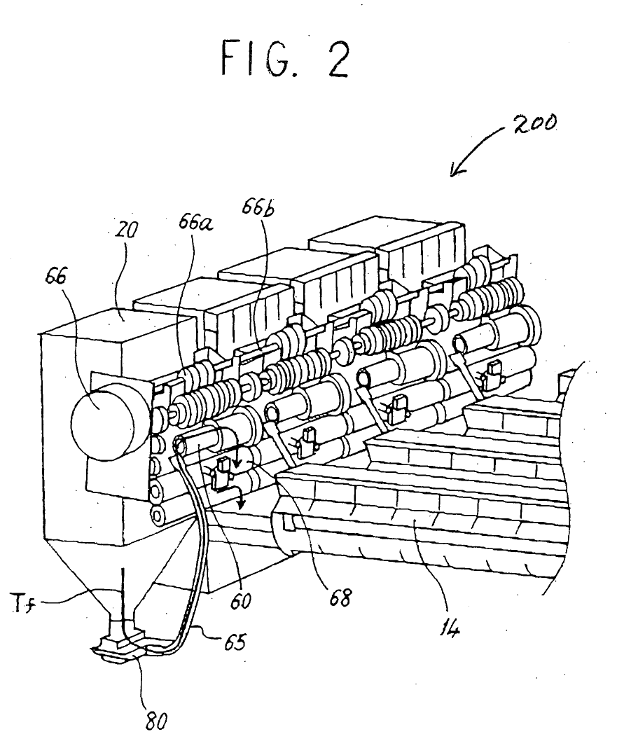

FIG. 2 shows a toner replenishing device 200 included in the tandem printer 100 in an external view. Labeled Tf in FIG. 2 is the flow of toner in the toner replenishing device 200. As shown, toner bottles 20 are arranged side by side on the front side of the tandem printer 100, which is a tandem, image forming apparatus. It is to be noted that the toner bottles 20 are a specific form of toner containers or powder containers each storing toner of a particular color. Each toner bottle 20 is connected to a replenishing unit, including a subhopper 88 and a toner pump 60, by a toner replenishing tube 65. The developing unit, including a developing device 14, is connected to the underside of the replenishing unit. In the illustrative embodiment, the toner pump 60 is implemented by a Mono pump or screw pump generally made up of an elastic stator formed with a spiral screw thereinside and a rotor rotatable within the stator for conveying toner in the axial direction. Alternatively, use may be made of a toner pump taught in Japanese Patent Laid-Open Publication No. 2000-98721, if desired.

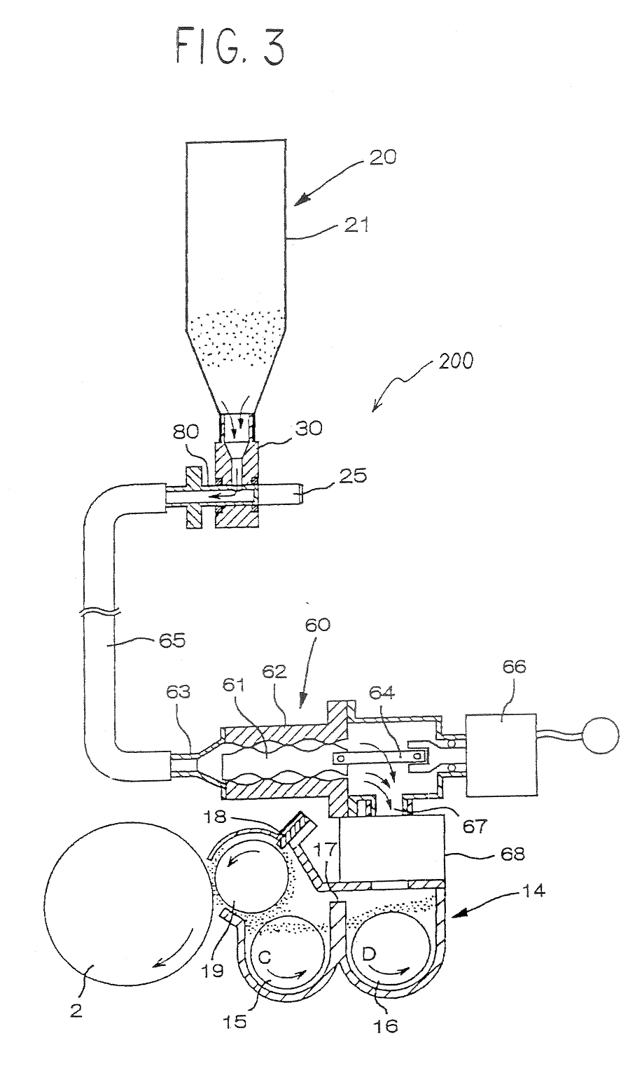

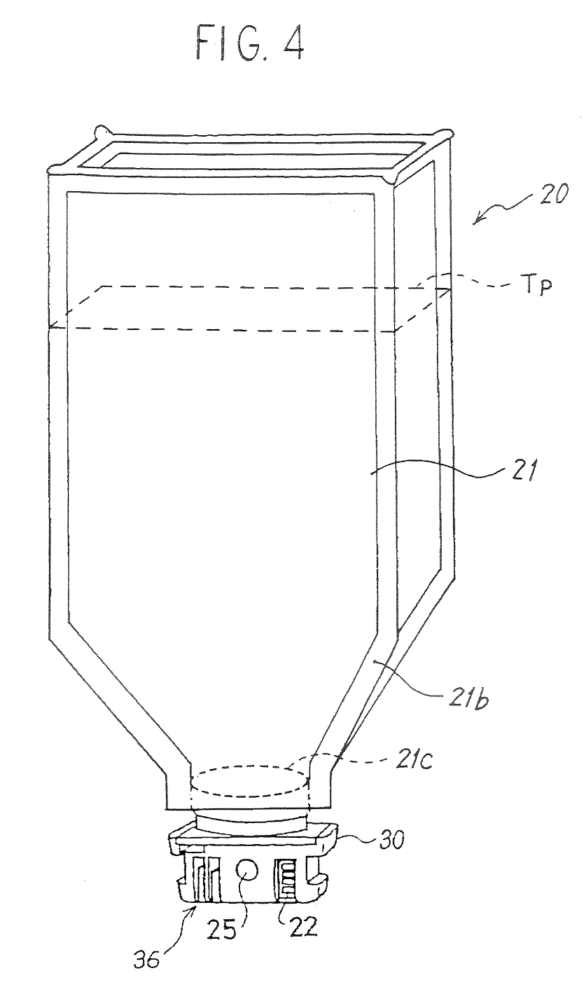

FIG. 3 is a section showing the toner replenishing device 200 while FIG. 4 is an external perspective view showing one of the toner bottles 20. As shown, the toner bottle 20 is made up of a toner or powder container or storing body 21 and a mouth member 30 including a toner outlet 21c, which is the only one powder outlet of the toner bottle 20. The configuration of the toner bottle 20 will be described more specifically later.

As shown in FIG. 3, when each toner bottle 20 is mounted to the body of the tandem printer 100, a nozzle 80, which serves as a connecting member to be connected to the mouth member 30, is inserted into the toner bottle 20. As a result, the toner outlet 21c is communicated to the toner inlet of the nozzle 80. The nozzle 80 includes a joint portion to which one end of the toner replenishing tube 65 is connected. The other end of the toner replenishing tube 65 is connected to the toner pump implemented by a Mono pump or screw pump, which is positioned in the subhopper portion and communicated to the developing unit 14. In this manner, the toner bottle 20 is automatically brought into communication with the developing unit 14 when mounted to the body of the printer 100.

Two screws 15 and 16, each having a spiral fin generally referred to as an auger, are disposed in the casing of the developing unit 14 and rotated in directions indicated by arrows C and D, respectively. A two-component type developer, i.e., a toner and carrier mixture exists around the screws 15 and 16. The screws 15 and 16 are configured to convey the developer, e.g., from the front to the rear, as seen in the direction perpendicular to the sheet surface of FIG. 3, and from the rear to the front, as seen in the same direction, respectively. Consequently, the developer is circulated in the developing unit 14 by the screws 15 and 16 via a front and a rear portion where a center partition 17 is absent while being agitated thereby.

Part of the developer thus being circulated in the developing unit 14 is magnetically deposited on a developing roller 19 and then transferred to the drum 2 while being metered to preselected thickness by a doctor blade 18, developing a latent image carried on the drum 2 to thereby produce a corresponding toner image. At this instant, only the toner contained in the developer is deposited on the drum 14. To maintain the toner content of the developer being circulated in the developing unit 14 constant, fresh toner is replenished from the toner bottle 20 to the developing unit 14 little by little.

The toner pump 60, or suction type single-axis eccentric screw pump as sometimes referred to, is generally made up of a rotor 61 and a stator 62. The rotor 61 is implemented as a hard shaft provided with a circular cross-section and spirally twisted and is connected to a drive motor 66 by a universal joint 64. The stator 62 is formed of rubber or similar soft material and formed with a bore provided with an oblong cross-section and spirally twisted at a pitch two times as great as the pitch of the spiral of the rotor 61. The rotor 61 is received in the stator 62 and rotated to convey the toner introduced in a space formed between the rotor 61 and the stator 62.

In the configuration shown in FIG. 3, the drive motor 66 and universal joint 64 are directly connected to each other. More specifically, as shown in FIG. 2, the output torque of the drive motor 66 is transmitted to the universal joint 64 via a drive shaft 66b and a drive shaft gear 66a.

Thus, when the rotor 61 of the toner pump 60 is rotated, fresh toner in the toner bottle 20 is sucked into the toner pump 60 via a suction port 63, conveyed from the left to the right in FIG. 3 by suction, and then fed to the developing unit 14 positioned below the toner pump 60 via a toner inlet 67 formed in the developing unit 14.

As shown in FIG. 4, the toner container or storing portion 21, forming part of the toner bottle 20 and storing fresh toner Tp, is implemented as a bag formed of a single soft, 50 μm to 300 μm thick sheet. This soft sheet is made up of a plurality of resin films different in material and stacked in the form of a single film. In the illustrative embodiment, the plurality of resin films comprise a welding layer formed of an easily adhering material, an air-tight layer formed of a highly air-tight material and a rigid layer formed of a highly rigid material.

For the welding layer, use is made of, e.g., polyethylene that melts at relatively low temperature while, for the air-tight layer and rigid layer, use is made of PET (PolyEthylene Terephthalate), nylon, aluminum, paper or similar material matching with the kind of the content to be stored, e.g., solid, liquid or powder and the purpose, e.g., food or medicine. In the illustrative embodiment, the toner container 21 of the toner bottle 20 is made up of a polyethylene layer, a nylon layer and a PET layer stacked in this order from the inside toward the outside.

More specifically, the welding layer, which is the innermost layer when the toner container 21 is configured as a bag, is formed of a material meltable at relatively low temperature, so that it evenly melts when heated and can therefore be closely welded at opposite edges thereof.

The toner Tp is sometimes deteriorated when exposed to outside air while in storage. Particularly, in a humid atmosphere, it is likely that the toner Tp coheres and cannot be smoothly replenished when exposed to outside air. In light of this, the air-tight layer is included in the bag member for enhancing air-tightness of the toner bottle 20.

Further, the tone bottle 20 must be easy to hold because the user directly touches it. In light of this, the relatively rigid sheet also included in the bag member provides the toner bottle 20 with desirable rigidity by having its thickness and therefore rigidity adjusted.

Of course, the toner bottle 20 may be provided with any other suitable layer or layers in addition to the three layers stated above.

The sheet members, constituting the toner container 21, are configured as a bag formed by repeating the steps of folding them such that opposite edges of the welding layer face each other and then welding them together. Alternatively, the toner container 21 may be formed by adhering the sheet members with adhesive like a paper bag. In this case, however, ridges are formed by folding a container and therefore not greater in strength than the other portions.

By contrast, in accordance with the illustrative embodiment, the toner container 21 includes welding margins 21b where two sheets are welded together, so that the resulting sheet thickness is two times as great as the thickness of the other portions. Consequently, the ridges of the toner container 21 play the role of “posts” that successfully increase the rigidity of the entire container. This prevents the toner container 21 from collapsing due to vibration during transport or an impact in the event of an accidental drop or prevents the flat portions around the toner outlet 21c from being deformed during toner replenishment and stopping the toner bottle 20.

As stated above, the toner container 21 is formed of sheets and therefore deformable in accordance with the configuration and/or the amount of the content, allowing the toner bottle 20 to be crumpled into, e.g., a small ball and collected when used up.

It is difficult to affix the toner container 21 to the toner replenishing device 200. To allow the toner bottle 20 to be surely set on the toner replenishing device 200, the toner container 21 may be affixed to the mouth member formed of, e.g., hard resin beforehand, and then the mouth member 30 maybe engaged with the toner replenishing device 200.

The mouth member 30 is formed of moldable resin. If the inner layer of the toner container 21 and the mouth member 30 are formed of polyethylene, they can be welded to each other without any clearance. To weld the mouth member 30 and toner container 21, part of the former maybe inserted into the latter and then applied with load by a heated, welding iron.

A toner container portion implemented by a bag-like member is lower in strength than a toner container formed of, e.g., hard resin and is likely to have its bag portion crashed when strongly held by hand in the event of replacement, causing part of the toner to be left in the toner container. In light of this, the toner container 21 may be provided with reinforcing members, as will be described specifically hereinafter.

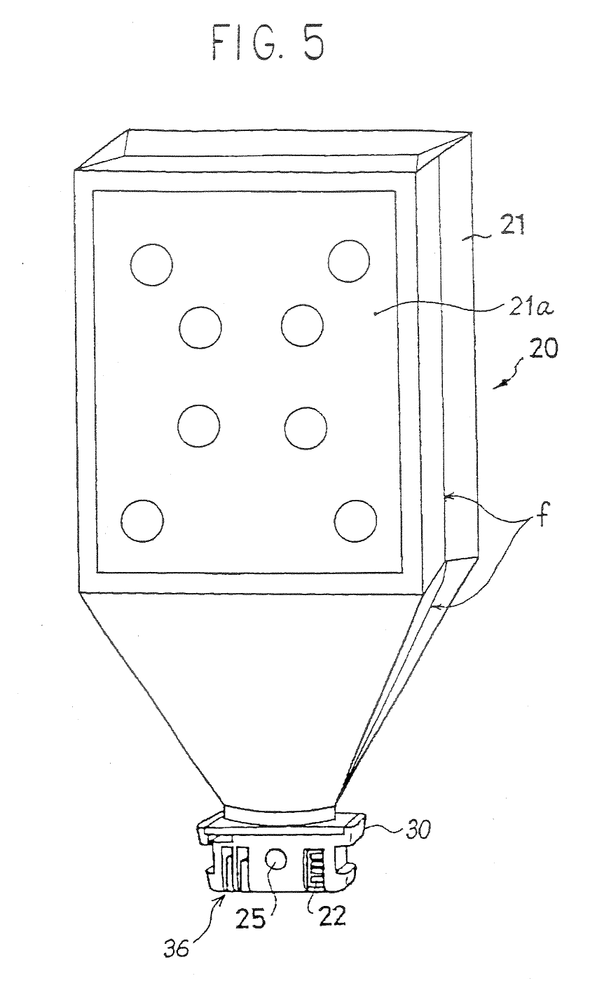

FIG. 5 is an external view showing a specific configuration of the toner bottle 20 in which the toner container 21 is provided with reinforcing plates or reinforcing members 21a. As shown, two reinforcing plates 21a (only one is visible) are respectively affixed to the outside flat surfaces of the front surface and rear surface, as seen in the direction perpendicular to the sheet surface of FIG. 5, of the toner container 21 and formed of PET, aluminum or similar material. Eight holes, for example, are formed in each reinforcing plate 21a, so that a person can easily hold the toner container 21 by catching the holes with fingers. Further, the toner container 21 is formed with folds f.

In the above configuration, portions provided with the reinforcing plates 21a deform little because of the reinforcing plates 21a and folds f and deform along the folds f. Consequently, the volume of the toner container 21 is reduced little by little with the container 21 being deformed to a desired shape, so that the amount of toner to be left in the container 21 when the above volume is decreased can be reduced.

The reinforcing plates 21a, affixed to the outside surfaces of the toner container 21, prevent the container 21 from being smashed in the event of replacement or from collapsing during transport. Further, the flat portions are prevented from deforming around the toner outlet and stopping the toner container 21.

The reinforcing members should preferably be thicker than the rigid layer when formed of the same material as the rigid layer or should preferably be more rigid than the rigid layer when thinner than the rigid layer.

In the specific configuration shown in FIG. 5, the reinforcing plates 21a are formed of about 0.2 mm thick PET or 0.2 mm to 0.3 mm thick PS.

The welding margins 21a, provided in the peripheral portions of the bag-like toner container 21, serve to increase the rigidity of the entire toner bottle 20, as stated previously. In addition, the reinforcing plates 21a, overlapping the welding margins 21b, play the role of “beams” extending between “posts”, further increasing the rigidity of the entire toner bottle 20. This prevents the flat portions of the toner container 21 from deforming around the toner outlet 21c during toner replenishment and stopping the toner bottle 20.

In the configuration shown in FIG. 5, each reinforcing plate 21a is sized such that it overlaps each welding margin 21b to about one-half of the welding margin 21b so as not to protrude from the toner container 21.

The plurality of holes, FIG. 5, formed in each reinforcing plate 21a prevent the user's fingers from slipping in the event of replacement of the toner bottle 20. When the reinforcing plate 21a is implemented by a PET or similar sheet material, the holes are formed by punching, so that burr is left around the holes. The burr, however, does not hurt the user's fingers in the event of replacement if the reinforcing plate 21a is mounted to the toner container 21 such that the burr faces the inside of the container 21a.

On the other hand, if the reinforcing plate 21a is mounted to the toner container 21 such that the bur faces the outside of the container 21, the plate 21a closely contacts the bag-like member and is therefore prevented from easily coming off when adhered to the bag-like member by, e.g., adhesive or a two-sided adhesive tape. Further, the burr around the holes faces the outside and therefore does not break or otherwise damage the bag-like member. Alternatively, after the holes have been formed by punching, the resulting burr may be removed.

When the reinforcing plate 21a is formed of, e.g., PS, it can be implemented as a molded member and therefore prevents burr from appearing around the holes if the contour and holes are molded at the same time. In addition, corners around the holes are removed by a molding step; otherwise, hurting the user's fingers.

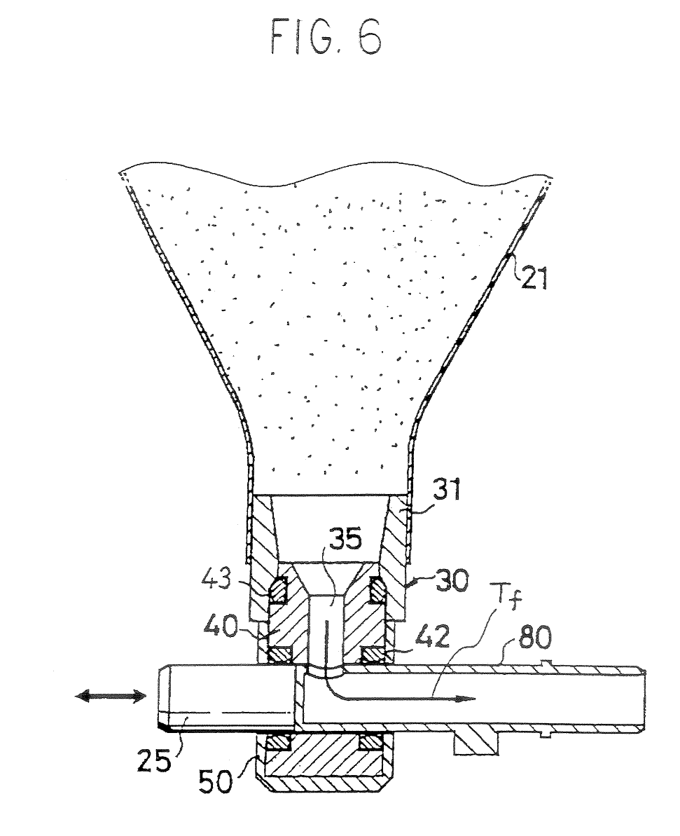

FIG. 6 is a section showing the portion of the toner bottle 20 around the mouth portion in the condition wherein the toner bottle 20 is set on the toner replenishing device 200. As shown, the mouth member 30 is made up of a top upper member 31, an inner member 40 and an outer member 50. The toner container 21 and outer member 50 are affixed to the top member 31. O-rings 42, having a pentagonal section each, are fitted on the inner member 40. The inner member 40 an O-rings 42 are held by the outer member 50. A shutter hole is formed throughout the inner member 40 and outer member 50 in order to receive a shutter member or cylindrical valve 25. Before the toner bottle 20 is used, the O-rings or seal members 42 is held in close contact with the periphery of the shutter member 25 in order to hermetically close the shutter hole. Further, a seal member 43, resembling an O-ring, is fitted between the outer inner periphery of the top member 31 and the outer periphery of the inner member 40. The mouth member 30 further includes a mounting portion 36, see FIG. 4, implemented as a slit different in configuration between the toner bottles 20, so that each toner bottle 20 is prevented from being confused from another toner bottle.

In the toner bottle 20 made up of the soft toner container 21 and mouth member 30, as stated above, an RF tag 22, see FIG. 4, is affixed to one side wall of the mouth member 30. The RF tag 22 is a data recording medium including a memory and configured such that data can be written to or read out of the memory by radio wave or electromagnetic wave. The data may include the type of an image forming apparatus applicable to the toner bottle 20 and toner stored therein, the color of toner, the date of production and the amount of toner remaining in the toner bottle 20.

How the toner bottle 20 is mounted to the body of the printer 100 will be described hereinafter.

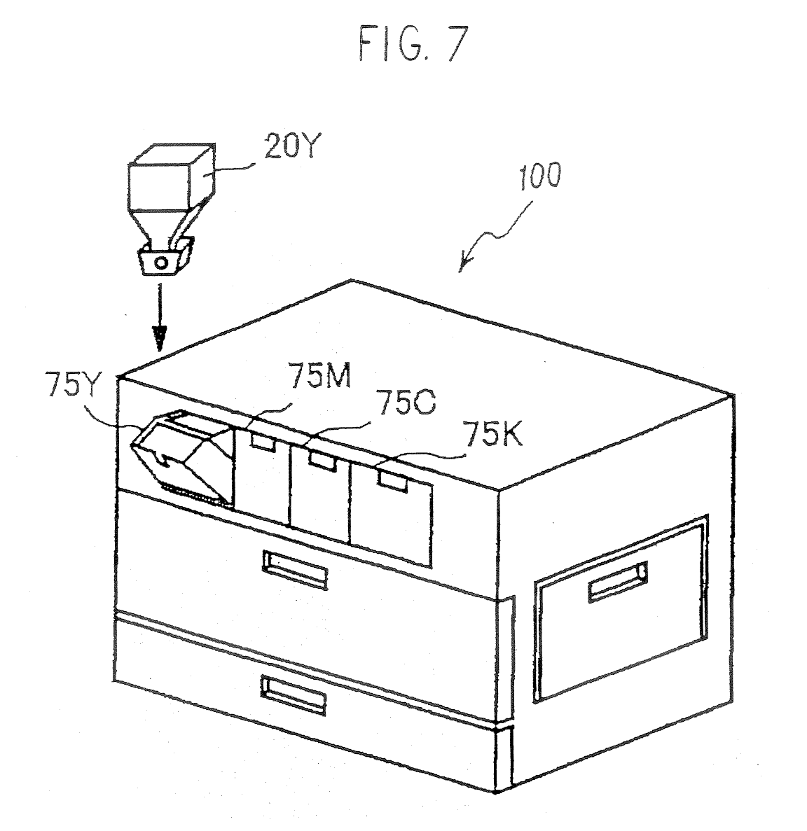

FIG. 7 is an external view showing the entire tandem printer 100. As shown, four bottle holders or bottle storing devices 75Y, 75M, 75C and 75K are mounted in the front portion of the casing of the printer 100 and pivotally movable about a shaft, not shown, into and out of the casing. The bottle holders 75Y through 75K each form part of a particular toner conveying device corresponding in color thereto and store and support one of the toner bottles 20 also corresponding in color thereto. To mount the toner bottle 20Y, for example, the operator unlocks the bottle holder 75Y, opens the bottle holder 75Y toward the operator to the position shown in FIG. 7, holds the toner container 21Y such that the mouth member 30 of the toner container 21Y faces vertically downward and then puts it in the bottle holder 75Y. Finally, the operator closes the bottle holder 75Y with the result that the toner bottle 20Y is set in the body of the printer 100.

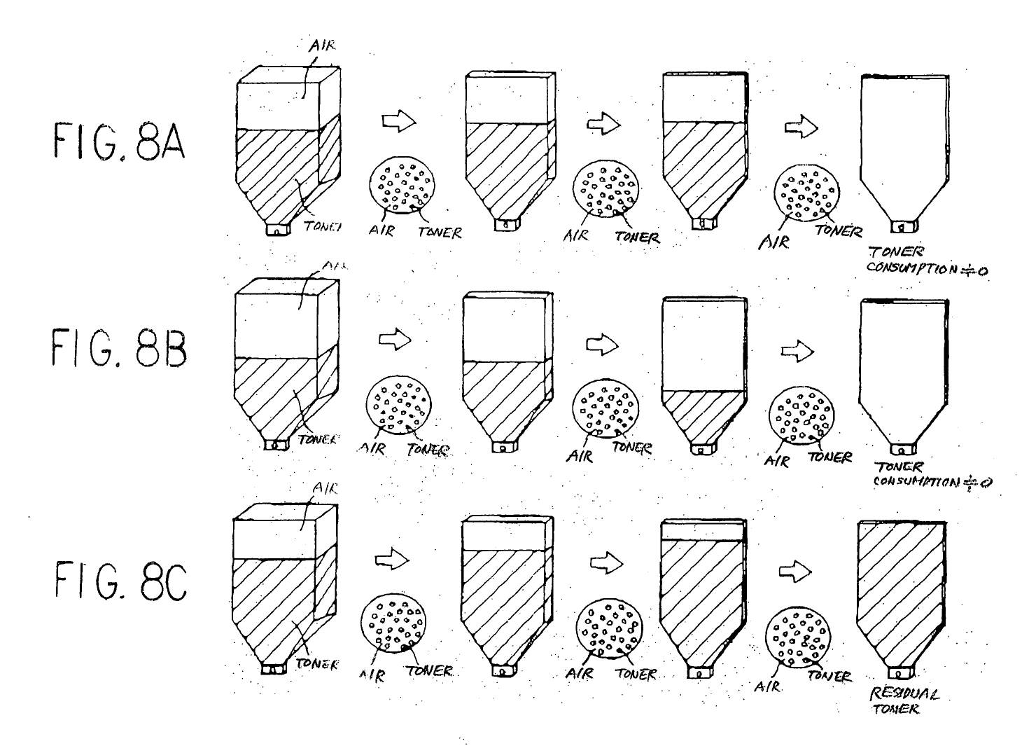

Reference will be made to FIGS. 8A through 8C for describing how the toner stored in the toner container 21 is consumed due to replenishment effected by the toner pump 60. FIGS. 8A, 8B and 8C show the consumption of toner occurring when the toner-to-air ratio is adequate, when it is small and when it is great, respectively. It is to be noted that the sections of FIGS. 8A through 8C indicate that air in the toner container 21 decreases little by little together with the toner.

When the toner pump 60 is driven, air pressure inside the toner pump 60 and replenishing tube 65 drops with the result that the toner in the toner container 21 of the toner bottle 20 is sucked out together with air around it.

When the amount of toner is adequate, as shown in FIG. 8A, or when the amount of air is great, as shown in FIG. 8B, substantially no toner is left in the toner container 21 at the end of consumption. Stated another way, the toner is fully consumed without being wasted. However, in the condition shown in FIG. 8B, the amount of toner that can be replenished is small for the apace occupied by the toner container 21 in the printer 100, obstructing the efficient use of the limited space available in the printer 100.

On the other hand, when the amount of air present between toner particles is small, friction between the toner particles increases and makes the mount of suction of the toner unstable or causes more toner to be left in the toner container 21. When the amount of air between the toner particles further deceases, the above friction becomes greater than the sucking force of the toner pump 60 and prevents the toner from being sucked.

The toner bottle 20 is hermetically sealed at all times, including the time of operation, by the O-rings or seals 42 and seal member 43 fitted on the shutter member or valve 25, so that the toner container 21 collapses little by little as the toner is replenished to the developing unit 14. While the toner can be fully consumed if a sufficient amount of air is sealed in the toner container 21 in the event of toner packing, air is entirely sucked out before the toner if the amount of air is short with the result that the toner is left in the toner container 21 in a so-called vacuum-packed condition.

In the illustrative embodiment, the volume of the deformable toner container 21 is assumed to be V which is the sum of “volume of toner” and “volume of air” (cm³).

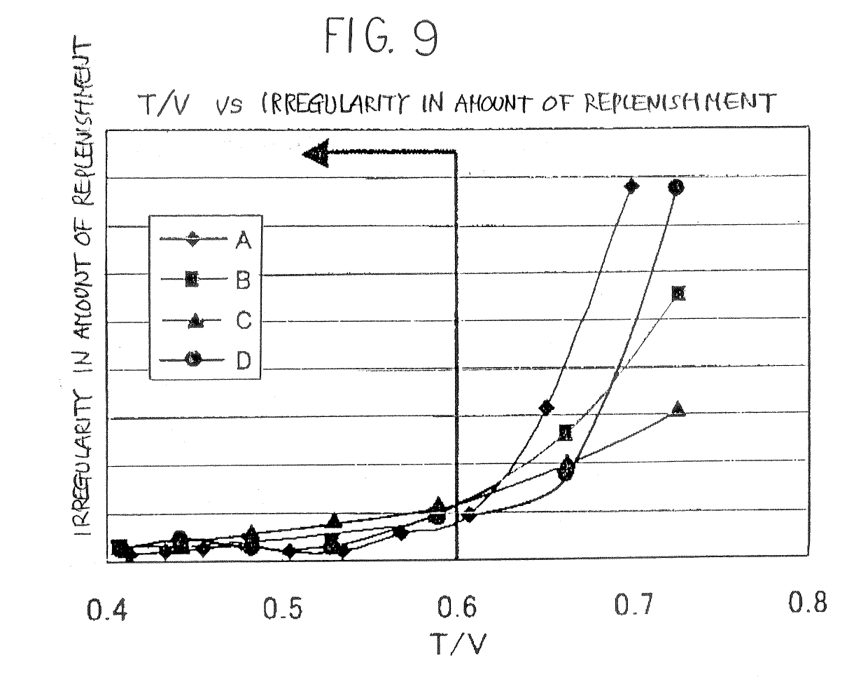

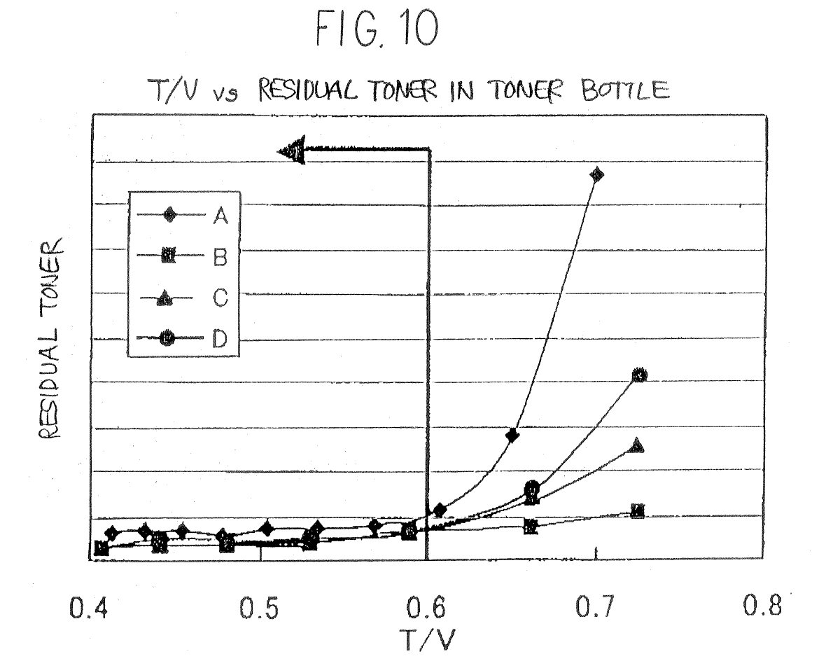

After setting the toner bottle 21 on the toner replenishing device 200, I varied the mass (g) of the toner relative the volume (V) of the toner container in order to measure irregularity in the amount of replenishment and the amount of toner left after consumption. FIGS. 9 and 10 are graphs showing the experimental results in which A, B and C are representative of magenta toner, yellow toner and cyan toner, respectively. More specifically, FIG. 9 shows how the amount of toner replenishment varied when a ratio T/V (g/vm³) is varied while FIG. 10 shows how the amount of toner left varied when the ratio T/V was varied.

As shown in FIG. 9, irregularity in the amount of toner replenishment was determined by determining a mean amount of replenishment Xave and a standard deviation Xα from the amounts of toner replenishment x1, x2, x3, . . . , xn actually measured for a preselected period of time. In FIG. 9, 2×Xα/Xave (%) is the irregularity. The irregularity in the amount of replenishment was calculated from measured amounts of replenishment except for those around the toner-end condition where the amount of replenishment becomes unstable. The amount of replenishment was provided with two standards, i.e., a mean value (g/min)±30 (%).

As shown in FIGS. 9 and 10, the greater the ratio T/V, the greater the irregularity in the amount of replenishment and the amount of toner left after replenishment. Particularly, the irregularity in the amount of replenishment sharply increased when the ratio T/V increased above 0.6/cm³. This is presumably because the amount of air in the toner container became short during replenishment and made it difficult for the toner pump to suck toner. Therefore, the ratio T/V should preferably be smaller than 0.6 g/cm³.

On the other hand, if the ratio T/V is excessively small, the amount of toner that can be replenished at a time decreases and results in low efficiency, so that it should preferably be greater than 0.4 g/cm³. More preferably, considering the efficiency of one time of replenishment, irregularity in the amount of replenishment and amount of toner left after replenishment, the ratio T/V should be greater than 0.45 g/cm³, but smaller than 0.55 g/m³. With this configuration, it is possible to fully use the toner without any waste while maintaining highly efficient toner replenishment for a space to be allocated to the toner bottle 20. Why the black toner A was left more than toner of the other colors in FIG. 10 is that the toner container 21 assigned to the black toner A was greater in size than the other toner containers.

The toner pump included in the toner replenishing device 200 and used in the above experiment had a sucking force of 4 kPa to 50 kPa, which decreases little by little with the elapse of time.

The toner to be used should preferably have a degree of acceleration cohesion of less than about 15 inclusive because toner with a high degree of acceleration cohesion is difficult to flow and cannot be stably replenished. Toner used in the experiment had a degree of acceleration cohesion of 9 to 11. To measure a degree of acceleration cohesion, POWDER TESTER PT-an available from HOSOKAWA MICRON was basically used and operated according to its operation manual except for the following:
(1)screens used: 75 μm, 45 μm, 22 μm
(2) vibration time: 30 sec

As for the mass T (g) of toner in the volume V (cm/³) of the toner container 21 used in FIGS. 9 and 10, the ratio between the volume of toner occupied in the toner container 21 and the volume of air contained therein is unknown. By determining the mass of toner for a unit volume after making spaces between toner particles even by tapping, there can be determined the volume of toner having a given mass T (g). The above mass of toner for a unit volume is assumed to be a tight bulk density D (g/cm³). The tight bulk density D was measured under the following conditions:
(1) Device: TAPPING MACHINE KRS-409 available from Kuramochi Kagakukikai Seisakusho
(2) Principle: By repeatedly applying mechanical movement to a toner bottle for thereby making spaces between toner particles even and then measure a volume
   Procedure:

(i) Affixing a toner bottle to a cylinder table at a drop height of 20 mm to 60 mm (20 mm in the illustrative embodiment)

(ii) 1,000 times to 2,000 times of vibration preset (150 times in the illustrative embodiment)

(iii) Moving the vibration table up and down up by the preset number of times at speed of 30 times/min

(iv) Mark toner level after the start and then calculate a tight bulk density as “bottom area” x “height to toner level”.

Basically, measurement was effected according to the operation manual of TAPPING MACHINE KRS-409 except that a cylinder was replaced with a toner bottle.

Thus, I found that the ratio between air and toner, i.e., bulk density of a toner bottle had influence on the discharge ability of the toner pump, and proposes a particular ratio. The precondition is therefore that the above ratio be adequately determined. This is because when toner is simply packed in container, the correlation between the volume and the discharge of the toner pump decreases because the volumes of spaces between toner particles are not the same. In light of this, I use a characteristic value referred to as a tight bulk density above.

A tight bulk density D measured with the toner used in the printer 100 was nearly 0.7 g/cm³.

Further, by dividing the volume T/D (cm³) occupied by toner by the volume V (cm³) of the toner container, it is possible to determine the ratio of the volume of toner occupied in the toner container to the above volume V.

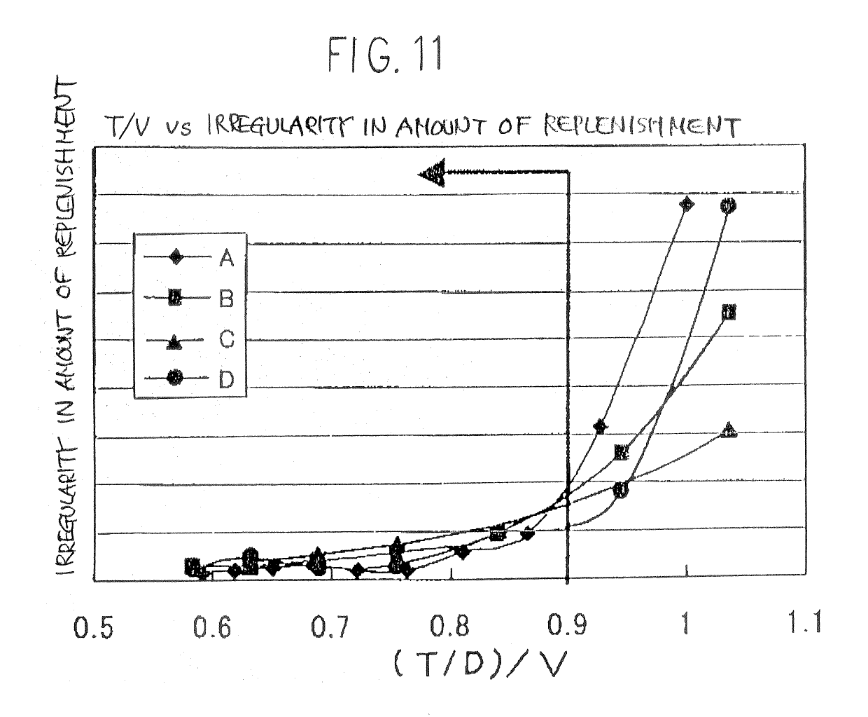

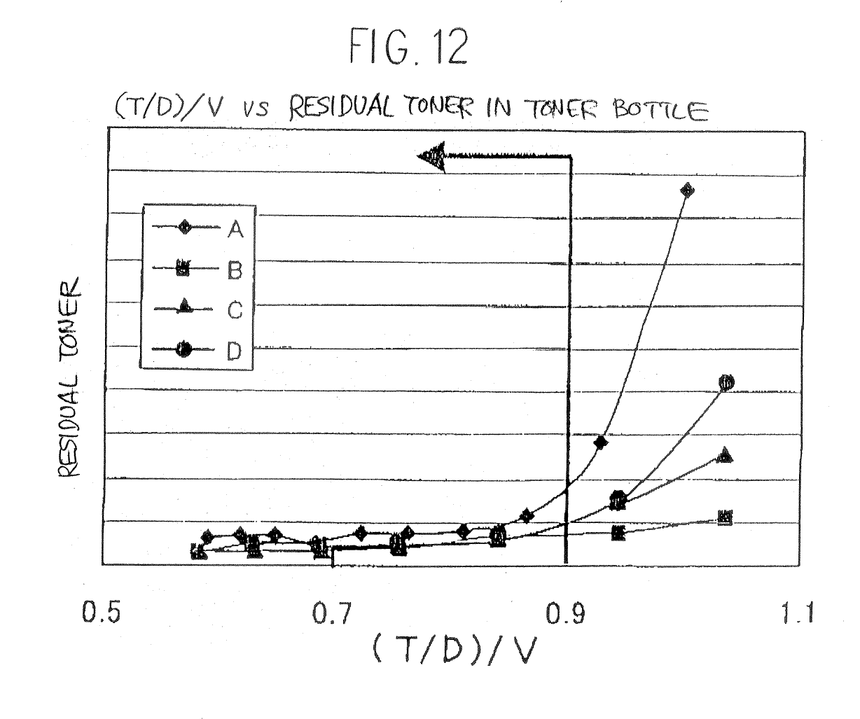

FIGS. 11 and 12 show a relation between the irregularity in the amount of replenishment and the amount of toner left, (T/D)/V, determined on the basis of the irregularity in the amount of replenishment shown in FIG. 9, the amount of toner left shown in FIG. 10 and the tight bulk density D of 0.7 g/cm³. More specifically, FIG. 11 shows irregularity in the amount of replenishment occurred when the ratio (T/D)/V was varied while FIG. 12 shows the amount of toner left when the same ratio was varied. Again, A, B and C indicate black toner, magenta toner, yellow toner and cyan toner, respectively.

As FIGS. 11 and 12 indicate, the greater the ratio (T/D)/V, the greater the irregularity in the amount of replenishment and the amount of toner left. Particularly, the irregularity in the amount of replenishment and the amount of residual toner sharply increased when the ratio (T/D)/V increased above 0.9. This is presumably because the amount of air in the toner container became short during replenishment and made it difficult for the toner pump to suck toner. Therefore, the ratio (T/D)/V should preferably be smaller than 0.9.

On the other hand, if the ratio (T/D)/V is excessively small, the amount of toner that can be replenished at a time decreases and results in low efficiency, so that it should preferably be greater than 0.5. More preferably, considering the efficiency of one time of replenishment, irregularity in the amount of replenishment and amount of toner left after replenishment, the ratio (T/D)/V should be greater than 0.65, but smaller than 0.75.

In summary, it will be seen that the present invention provides a toner bottle allowing toner stored in a toner bottle to be fully used while maintaining the efficiency of the above toner high for a space to be occupied by the toner bottle. Also, by using a sheet member as a toner container included in the toner bottle, it is possible to reduce the amount of resin to form the toner bottle and therefore save resources. This is because the toner container does not have to be configured as a conventional hard bottle, which needs strength, and can therefore be made thinner for a given surface area. In addition, the toner bottle after use can be stored and collected at low cost because it automatically collapses.

Further, the toner bottle or toner container insures stable toner replenishment free from waste while stabilizing toner content in a toner replenishing device for thereby insuring desirable image formation.

Various modifications will become possible for those skilled in the art after receiving the teachings of the present disclosure without departing from the scope thereof.

What is claimed is:

1. In a powder container comprising a powder storing body configured to store powder thereinside and a powder outlet configured to discharge said powder from said powder storing body, said powder storing body being caused to discharge said powder to an outside by vacuum acting on said powder outlet from the outside for thereby decreasing a volume of said powder storing body,
the powder has a tight bulk density D, which refers to a density of said powder measured in a condition wherein air between particles of said powder is discharged as far as possible, lying in a range of:
0.5<(T/D)/V<0.9
where V denotes a volume of said powder storing body before a start of discharge of the powder and T denotes a mass of said powder in said powder storing body.

2. The powder container as claimed in claim 1, wherein said powder storing body comprises a soft bag-like member.

3. The powder container as claimed in claim 1, wherein the powder comprises toner.

4. A toner replenishing device comprising:
a toner container configured to store toner;
a toner conveying device configured to convey the toner; and
a toner pump configured to cause vacuum to act on the toner stored in said toner container for thereby replenishing said toner to a destination via said toner conveying device;
wherein the toner has a tight bulk density D, which refers to a density of said toner measured in a condition wherein air between particles of said toner is discharged as far as possible, lying in a range of:
0.5<(T/D)/V<0.9
where V denotes a volume of said powder storing body before a start of discharge of the toner and T denotes a mass of said toner in said powder storing body.
